(19) United States
(12) Patent Application Publication
(10) Pub. No.: US 2011/0247626 A1
(43) Pub. Date: Oct. 13, 2011

(54) Mask

(76) Inventor: Chin-Fu Chuang, Tainan City (TW)

(21) Appl. No.: 12/798,811

(22) Filed: Apr. 13, 2010

(51) Int. Cl. A62B 23/02

(52) U.S. Cl. 128/206.19

(57) ABSTRACT

A mask includes an airtight wrapper and a filtering cotton. The airtight wrapper further includes an airy opening and an airy covering. With the airy covering able to be engaged with and disengaged from the airy opening, the filtering cotton can be fixed immovably between the airy opening and the airy covering for use and taken away easily in case of needing to clean the airtight wrapper and the filtering cotton. Thus the airtight wrapper can be washed and the filtering cotton can be replaced with a new one if necessary, properly saving resource.

### BACKGROUND OF THE INVENTION

1. Field of the Invention

This invention relates to a mask, particularly to one having independent filter cotton that can be immovably positioned and easily taken away by engagement and disengagement of an airy opening and an airy covering of an airtight wrapper, enabling the mask conveniently washed and used for a longer life.

2. Description of the Prior Art

Commonly, as shown in FIG. 1, a conventional N95 mask is made by having a filter cloth integrally combined with a mask envelope. As unable to be washed for reusing, the mask is usually thrown away in case of being contaminated or wetted, posing a waste of money and resource.

### SUMMARY OF THE INVENTION

The object of this invention is to offer a mask able to make a filtering cotton immovably positioned and easily taken away by engagement and disengagement of an airy opening and an airy covering of an airtight wrapper, so as to provide a practical and sanitary mask.

The main characteristics of the invention are an airtight wrapper and a filtering cotton. The airtight wrapper is not made of cotton or cloth, provided with two bands connecting two sides, a recessed airy opening and an airy covering. The filtering cotton is installed in the airy opening of the airtight wrapper, able to be a combination of activated carbon and cotton.

### BRIEF DESCRIPTION OF DRAWINGS

This invention is better understood by referring to the accompanying drawings, wherein:

FIG. 1 is a perspective view of a conventional mask;

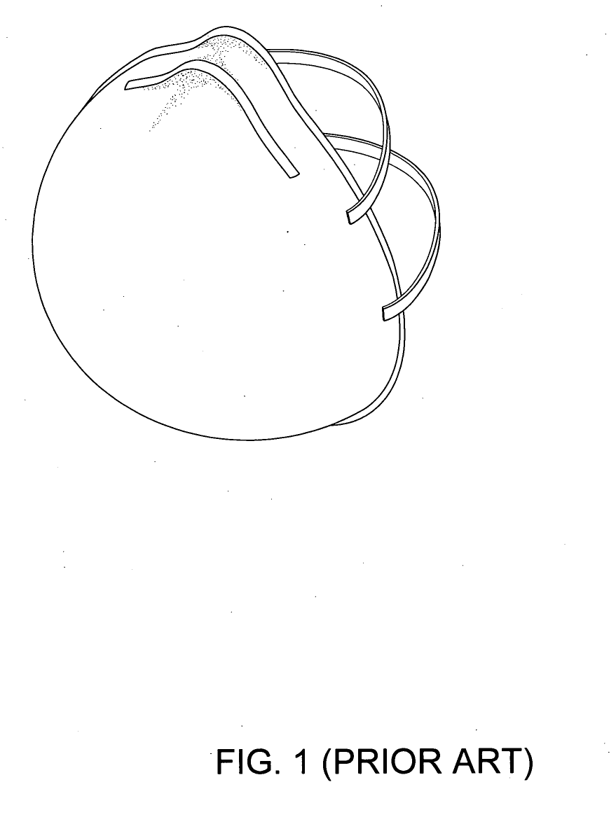

FIG. 2 is an exploded perspective view of a preferred embodiment of a mask in the present invention;

FIG. 3 is a perspective view of the preferred embodiment of a mask in the present invention;

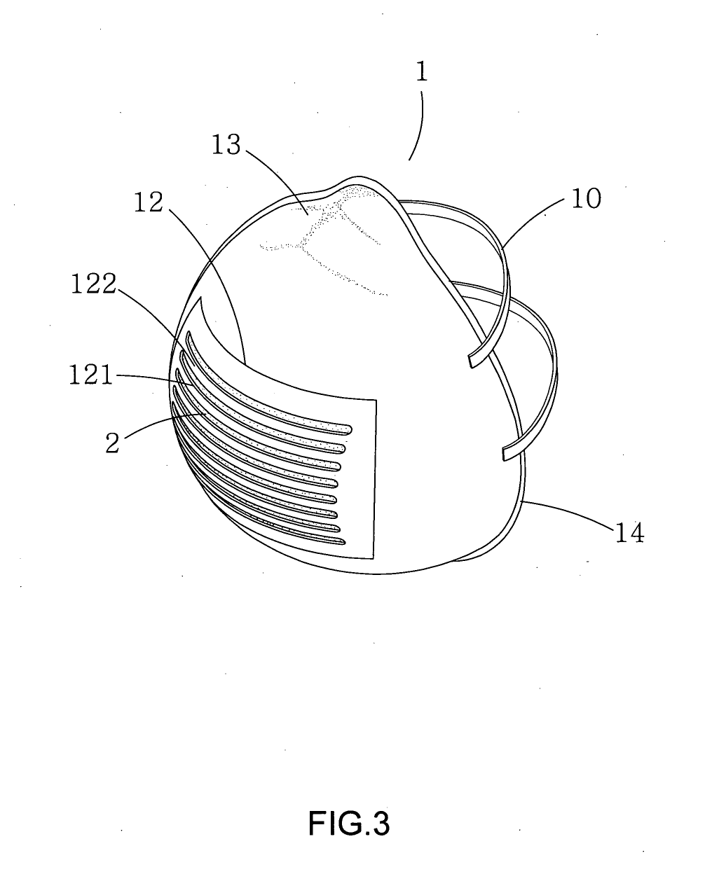

FIG. 4 is a cross-sectional view of the preferred embodiment of a mask in the present invention; and

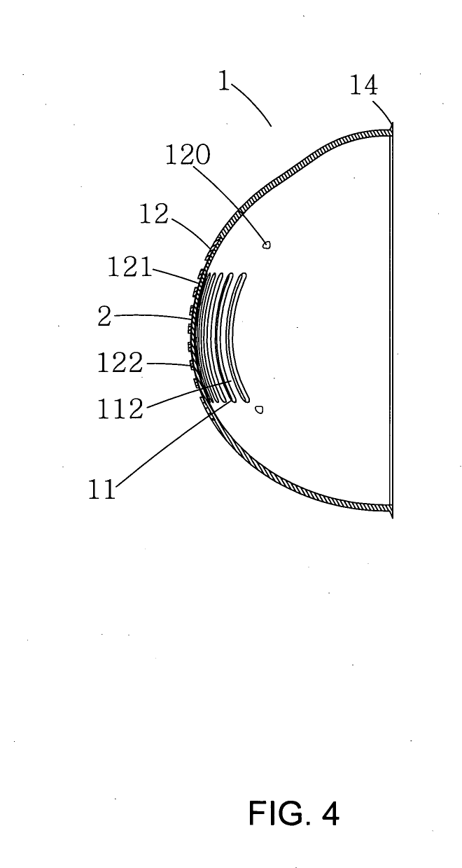

FIG. 5 is a perspective view of the preferred embodiment of a mask in the present invention, showing it being worn by a user.

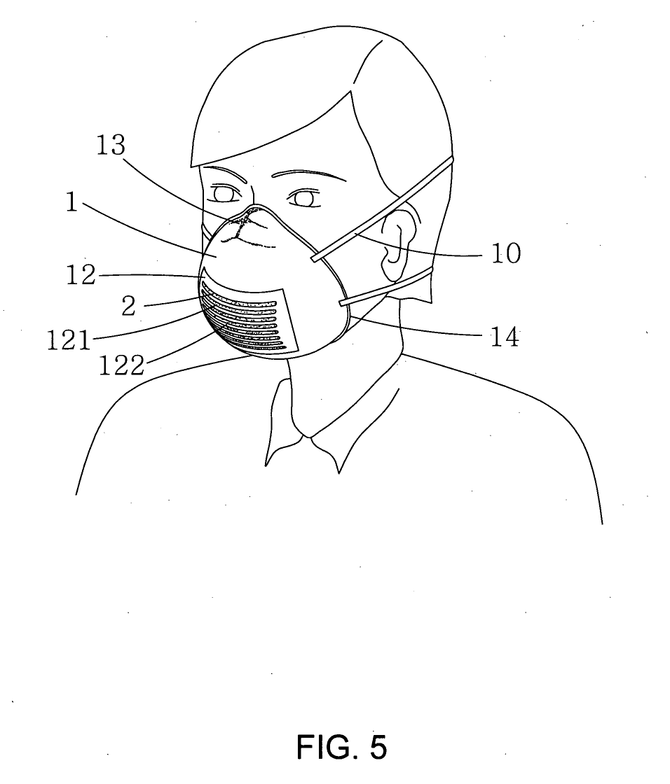

### DETAILED DESCRIPTION OF THE PREFERRED EMBODIMENT

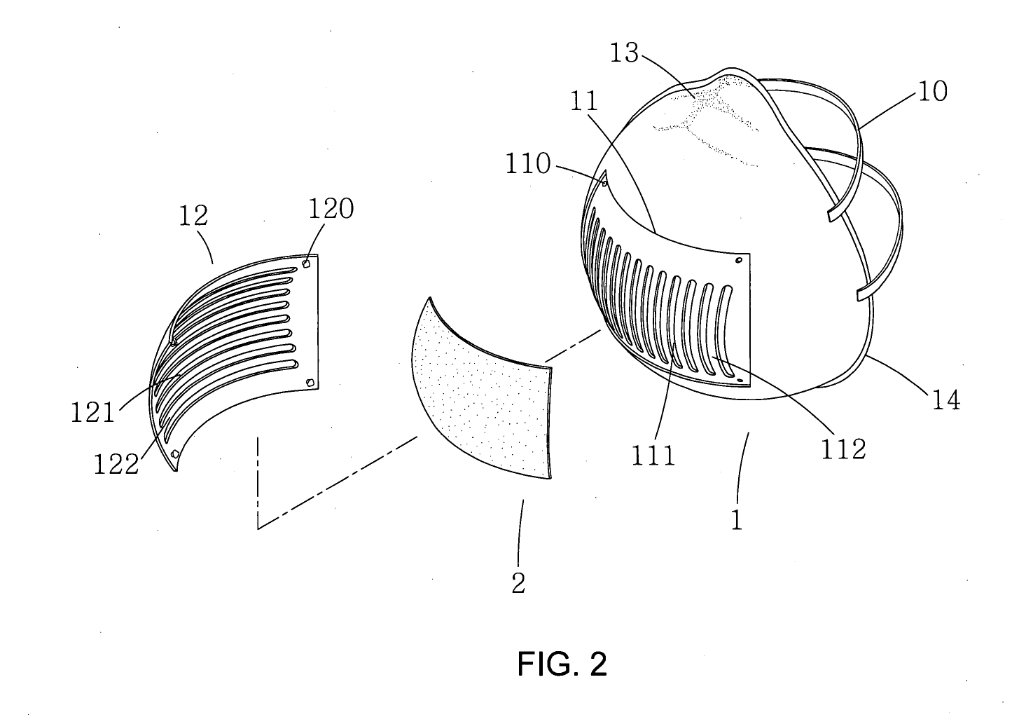

As shown in FIGS. 2˜5, a preferred embodiment of a mask in the present invention is composed of an airtight wrapper 1 and a filtering cotton 2.

The airtight wrapper 1 is not made of cotton or cloth, but those such as rubber or the like, integrally formed by a mold. The airtight wrapper 1 is provided with two bands 10 connecting two sides, a recessed airy opening 11 and an airy covering 12. The airy opening 11 includes plural positioning holes 110 bored at circumferential corners, plural vertical air grooves 111 and plural strips 112 respectively formed between every two neighboring air grooves 111. The airy covering 12 is provided with plural engaging projections 120 corresponding to the positioning holes 110 of the airy opening 11, plural horizontal air grooves 121 and plural strips 122 respectively formed between every two neighboring air grooves 121. And the airtight wrapper 1 is further provided with a nose portion 13 located at a top, and a face portion 14.

The filtering cotton 2 is installed in the airy opening 11 of the airtight wrapper 1, made of filtering cotton or activated carbon filtering cotton, with a size larger than those of the air grooves 111. By engaging the airy covering 12 with the airy opening 11, the filtering cotton 2 is sandwiched between the strips 112 of the airy opening 11 and the strips 122 of the airy covering 12.

In using, the airy covering 12 is first removed from the airtight wrapper 1 and then the filtering cotton 2 is laid in the airy opening 11. Next, the airy covering 12 is put on the airy opening 11, with the positioning holes 110 of the airy opening 11 locked by the engaging projections 120 of the airy covering 12 so as to keep the airy covering 12 firmly fixed on the airtight wrapper 1. Successively, the mask can be worn by a user, with the bands 10 tied close to the ears, with the nose portion 13 attached on the nose and the face portion 14 attached on the face. By the time, air can only pass through the filtering cotton 2 in the airy opening 11. When the filtering cotton 2 in the airtight wrapper 1 is to be replaced with a new one, it is just necessary to pull the engaging projections 120 of the airy covering 12 off the positioning holes 110 of the airy opening 11 so that the airy covering 12 may be separated from the airy opening 11, enabling the filtering cotton 2 to be freely taken away.

The invention has the following advantages as can be seen from the foresaid description.

1. With the airy covering 12 able to be easily engaged with or disengaged from the airy opening 11, the filtering cotton 2 can be conveniently replaced with a new one, and the airtight wrapper 1 itself can be washed for reuse.

2. By means of a firm interlocking between the airy opening 11 and the airy covering 12, the filtering cotton 2 is thereby positioned immovably to have a practical performance.

3. As the filtering cotton 2 is replaceable, a variety of filtering cotton and activated carbon filtering cotton can be chosen according to practical need.

4. The filtering cotton 2 can be effectively used to achieve the purpose of resource induction.

5. After being washed, the airtight wrapper 1 can be wiped dry for being immediately combined with filtering cotton 2.

While the preferred embodiment of the invention has been described above, it will be recognized and understood that various modifications may be made therein and the appended claims are intended to cover all such modifications that may fall within the spirit and scope of the invention.

What is claimed is:

1. A mask comprising:
an airtight wrapper made of those that are not cotton or cloth and provided with two bands connecting two sides, a recessed airy opening and an airy covering formed at a front of said airtight wrapper; and
a filtering cotton installed in said airy opening of said airtight wrapper and being a combination of activated carbon and cotton.

2. The mask as claimed in claim 1, wherein said airy opening of said airtight wrapper is provided with plural positioning holes employed to be locked by plural corresponding engaging projections of said airy covering so as to keep said filtering cotton positioned in said airtight wrapper.

3. The mask as claimed in claim 1, wherein said airtight wrapper is further provided with a nose portion located above said airy opening.

4. The mask as claimed in claim 1, wherein said airtight wrapper is further provided with a soft face portion for well wrapping a user's mouth so as to keep air merely passing through said filtering cotton on said airy opening.
